(19) United States
(12) Patent Application Publication
(10) Pub. No.: US 2008/0279998 A1
(43) Pub. Date: Nov. 13, 2008

(54) Electric toaster

(76) Inventor: Chung Sik Park, Sunnyvale, CA (US)

Correspondence Address: PATENT OFFICE OF DR. CHUNG S. PARK, P. O. BOX 62312, SUNNYVALE, CA, 94088-2312, US

(21) Appl. No.: 11/801,288

(22) Filed: May 9, 2007

(51) Int. Cl. A47J 37/08; A23L 1/01

(52) U.S. Cl. 426/466; 99/331

(57) ABSTRACT

A toaster having at least one toasting slot includes at least one sensor operative to generate a sensor signal indicating whether or not a food item is loaded in said slot and heating elements for generating heat energy to toast a food item loaded in the toasting slot by use of an electrical current. The toaster also includes at least one switching unit that is responsive to the sensor signal and operative to control the electrical current flowing through the heating elements such that the switching unit cuts off the electrical current when the slot is unloaded.

### FIELD OF THE DISCLOSURE

The present disclosure relates to electric toasters, and more particularly, to electric toasters with enhanced energy saving mechanisms.

### BACKGROUND

Nowadays, an electric toaster is one of the most essential electric appliances in the common household kitchen. A conventional electric toaster may have one or more toasting chambers and each toasting chamber has one or more toasting slots for toasting bread or food items. Hereinafter, the term toasting slot refers to a space for loading/unloading a food item(s) of a conventional size. Also, the terms toasting chamber and toasting slot are used interchangeably. The user puts food items to be toasted in the toasting chambers, sets a timing unit to a desired level, and pushes an operating knob down to activate the heating elements in the chambers and, in a minute or so, the food items are ready to be served.

If a toaster has a single operating knob with multiple toasting slots, the maximum number of food items to be toasted simultaneously is equal to the total number of toasting slots in the toaster. Quite often, one or more of the multiple slots are not loaded with food items during a toasting cycle, i.e., the toaster is partially loaded with food items during operation. In such cases, the heat energy generated by the heating elements in the unloaded (or, equivalently, empty) slots is wasted during operation. Furthermore, the heating elements of the empty slots may raise an operational safety issue since any foreign material, such as spoon or knife, inadvertently inserted thereinto during operation can inflict injury on the user and damage the toaster. As such, there is a need for a toaster with a mechanism to reduce the waste of energy and to address the safety issue, thereby to save operational cost with enhanced safety for the user.

### SUMMARY

In one embodiment of the present disclosure, a toaster having at least one toasting slot includes: at least one sensor operative to generate a sensor signal indicating whether or not a food item is loaded in said slot; heating elements for generating heat energy to toast a food item loaded in the toasting slot by use of an electrical current; and at least one switching unit responsive to the sensor signal and operative to control the electrical current.

In another embodiment of the present disclosure, a method for operating a toaster having at least one toasting slot with heating elements to be energized by an electrical current from a power source includes steps of: causing a sensor associated with the toasting slot to generate a signal that indicates whether or not a food item is loaded in said slot; and causing a switching unit coupled to the power source to control the electrical current in response to the signal.

### BRIEF DESCRIPTION OF THE DRAWINGS

FIG. 1 shows a schematic partial cutaway view of an exemplary toaster in accordance with one embodiment of the present invention.

FIG. 2 shows a schematic cross sectional view of the toaster in FIG. 1, taken along the line II-II.

FIG. 3 shows an enlarged view of a portion of the toaster in FIG. 2.

FIG. 4 shows a schematic diagram of an embodiment of a switch circuit of the toaster in FIG. 1.

FIG. 5 shows a schematic diagram of another embodiment of a switch circuit of a toaster.

FIG. 6 shows a schematic diagram of yet another embodiment of a switch circuit of a toaster.

FIG. 7 shows a schematic top plan view of another embodiment of a sensor mounted on a rack of a toaster.

FIG. 8 shows a schematic cross sectional view of the sensor in FIG. 7, taken along the line VIII-VIII.

FIG. 9 shows a schematic diagram of an embodiment of a switch circuit for the sensor in FIG. 7.

FIGS. 10A-C show schematic cross sectional views of various embodiment of a sensor of the type used in the toaster of FIG. 1.

FIG. 11 shows a schematic top plan view of yet another embodiment of a sensor of a toaster.

FIG. 12 shows an enlarged view of a portion of the toaster in FIG. 11.

### DETAILED DESCRIPTION OF THE PREFERRED EMBODIMENTS

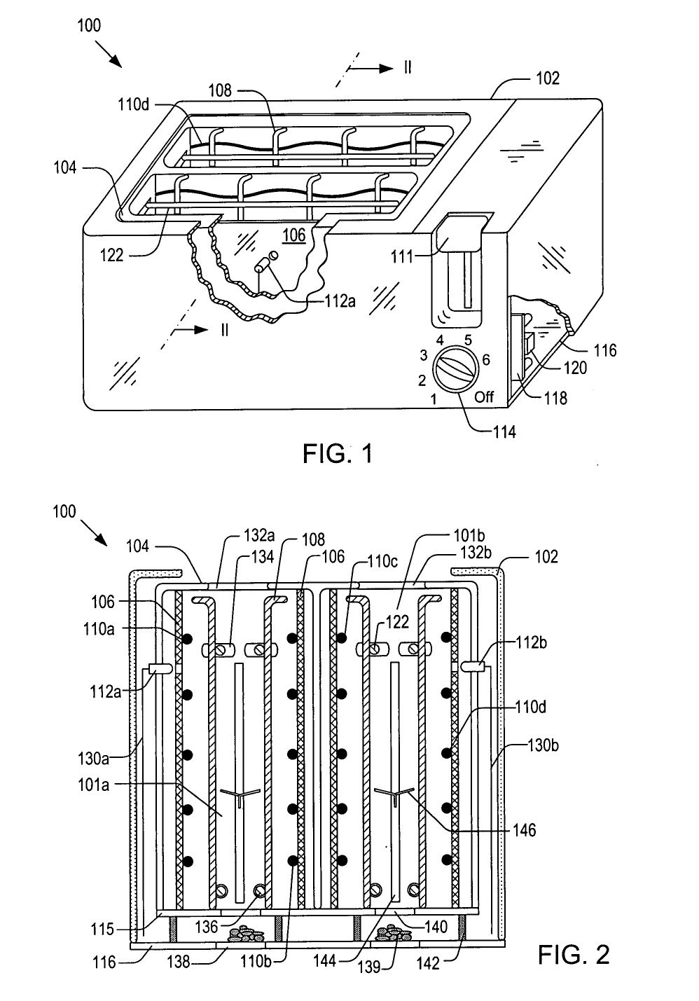

FIG. 1 shows a schematic partial cutaway view of an exemplary toaster 100 in accordance with one embodiment of the present invention. FIG. 2 shows a schematic cross sectional view of the toaster 100, taken along the line II-II. As depicted, the toaster 100 includes an outer housing 102, an inner housing or shielding 104, and two toasting chambers 101a, 101b that are respectively provided with two top openings 132a and 132b at the top of the shielding 104. Bread or food items to be toasted are introduced into or retrieved from the toasting chambers through the top openings 132a, 132b. For the purpose of illustration, each toasting chamber 101a (or 101b) is dimensioned to toast one slice of bread at each cycle, i.e., each toasting chamber has one toasting slot. However, it should be apparent to those of ordinary skill that each toasting chamber may be dimensioned to simultaneously toast any other suitable number of food items or slices of bread.

The toaster 100 also includes electric heating units or elements 110a-110d for generating heat energy to toast the food items. Each heating unit is secured to a mica sheet 106 by a suitable method, such as ribbon-type stiffeners (not shown in FIG. 1). Each heating element can be an electrically resistive ribbon(s) or wire(s) to convert electrical energy into radiation and convection. Two types of heat transfer from the heating element 110a-110d to food items take place concurrently: direct radiation, either visible or infra red, and convection movement of air in proximity to the heating elements.

The inner housing or shielding 104 shields heat transfer from the heating elements 110a-110d to the outer housing 102. The outer housing 102 is formed of, for instance, heat resistance plastic, while the inner housing or shielding is formed of heat reflecting/shielding material, such as metal, for instance. The shielding 104 reflects the radiation incident thereupon toward the bread and reduces convective heat transfer to the outer housing 102. In an alternative embodiment, the space between the outer housing 102 and the shielding 104 may be filled with thermally insulating material.

The toaster 100 also includes: a timing unit 114 for allowing the user to set a toasting cycle interval; a manually operating knob 111; and movable bread supporting racks 146 that are disposed in the toasting chambers 101a, 101b and in structural communication with the knob 111. The racks 146 are movable vertically among a lower limit position, and an upper limit position, and a toasting position between the lower and upper limit positions and located much closer to the lower limit position as compared to the upper limit position. The food items to be toasted are loaded on and unloaded from the racks 146 when the racks are in the upper limit position. The food items to be toasted are toasted in the toasting chambers 101a, 101b when the racks 146 are in the toasting position. Upon loading the food items on the racks 146, the user moves the operating knob 111 down to the lower limit position and releases the knob. Then, a conventional retaining mechanism (not shown in FIGS. 1-2), for instance, an electromagnetic attraction mechanism, maintains the racks 146 in the toasting position during a toasting cycle. The timing unit 114 is operable so as to de-energize the retaining mechanism at the end of the toasting cycle, thereby to cause the racks 146 to move to the upper limit position. Each of the racks 146 moves along one of vertical slots 144 formed in the inner housing or shielding 104.

Within each toasting chamber there are vertically disposed grids 108 that will contact with bread being toasted and are intended to prevent the bread from being charred by contact with the heat elements 110a-110d. The grids 108 are secured to upper horizontal grid ribs 122 and lower horizontal grid ribs 136. The lower grid ribs 136 are pivotedly mounted on the shielding 104 while the upper grid ribs 122 are slidably mounted on the shielding 104. In each of the toasting chambers 101a, 101b, the upper and lower horizontal grid ribs 122,136 are in structural communication with the operating knob 111 such that the upper horizontal grid ribs 122 slides along the slots 134 toward the food item when the user moves the operating knob 111 down to the lower limit position. Likewise, in each toasting chamber, the upper grid ribs 122 move along the slots 134 away from the bread when the operating knob 111 moves to its upper limit position at the end of a toasting cycle.

The toaster 100 also includes inner bottom plate 115 and an outer bottom plate 116 that is positioned below the inner bottom plate and separated from the inner bottom plate 115 by multiple spacers 142. The inner bottom plate 115 reflects/shields the radiation incident thereupon toward the food items and reduces convective heat transfer to the outer bottom plate 116. The inner bottom plate 115 is formed of, for instance, metal and includes a plurality of bottom slots or openings 140. The outer bottom plate 116 is formed of, for instance, heat resistance plastic and includes one or more slidable trays 138. Bread crumbs or debris 139 broken off of the food items pass through the openings 140 and accumulate on the slidable trays 138. The slidable trays 138 can be separated from the outer bottom plate 116 for cleaning.

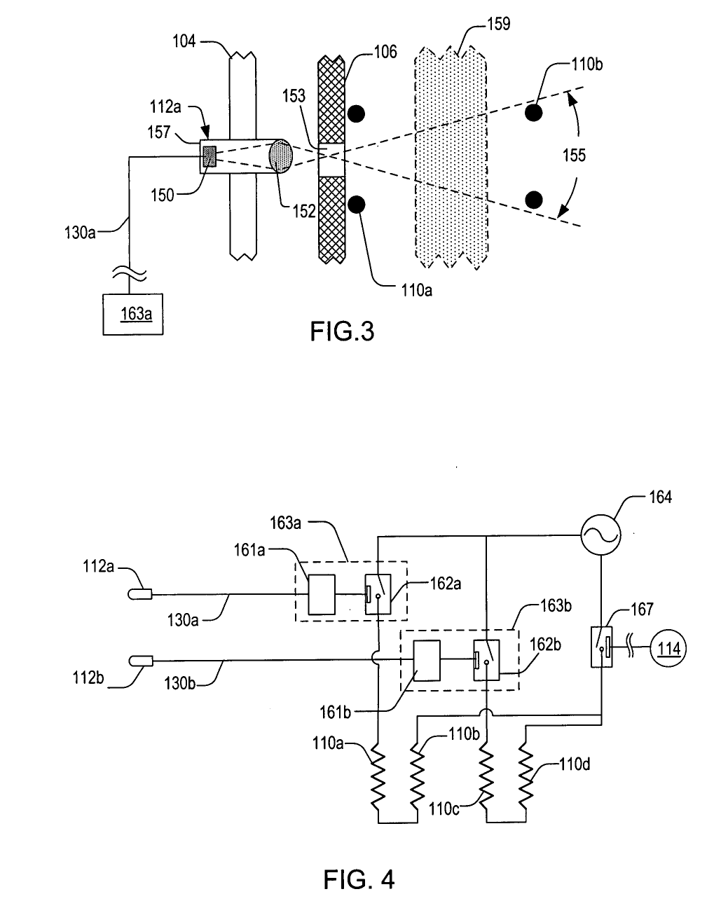

The toaster 100 includes a circuit board 118 upon which electrical components, such as timing unit readout, are mounted. The toaster 100 also includes two sensors 112a, 112b that are coupled to switching units via electrical wires 130a, 130b. The sensor 112a has the same structure and operational mechanism as the sensor 112b. FIG. 3 shows an enlarged view of a portion of the toaster in FIG. 2, illustrating details of the sensor 112a. For brevity, the grids 108 are not shown in FIG. 3. As depicted, the sensor 112a passes through a hole formed in the shielding 104 and is secured to the shielding 104 while the mica sheet 106 includes a hole or opening 153 such that a portion of the heating element 110b is disposed within the field of view 155 of the sensor 112a through the hole 153.

The sensor 112a is a photo-detective sensor and includes a means for collecting radiation 152, such as lens, and a photosensitive element 150. In one exemplary embodiment, the sensor 112a includes a hollow cylinder having the lens 152 at one end and a circular plate 157 at the other end, wherein the photosensitive element is fixedly mounted to the circular plate 157. The lens 152 may be formed of typical lens material, such as quartz or glass, that is transparent to the radiation emitted by the heating elements 110b during operation. It is noted that the sensor 112a can be securely mounted to the shielding 104 in other manners. For instance, the circular plate 157 is mounted to the surface of the shielding 104 by soldering or suitable fastening mechanism.

When the user moves down the operating knob 111 without loading any food item in the toasting chamber 101a, a portion of the radiation energy emitted by the heating element 110b within the field of view 155 is directed by the lens 152 onto the photosensitive element 150. The radiation energy includes, but is not limited to, visible and infra-red light energy, and the photosensitive element 150 generates, in response to the radiation energy incident thereon, an electrical signal indicating the absence of food item in the chamber 101a. The electrical signal is transmitted to a switching unit 163a via the electrical wire 130a. Then, as will be described in detail with reference to FIG. 4, the switching unit 163a disconnects electrical current flow to the heating elements 110a and 110b, thereby saving the energy that would be otherwise wasted during the toasting cycle. If a food item 159 is loaded in the toasting chamber 101a prior to or during the toasting cycle, the radiation energy emitted by the heating element 110b is blocked by the food item 159, thereby the sensor 112a generates an electrical signal indicating the presence of food item 159 in the chamber such that the switching unit 163a couples the heating elements 110a, 110b to the power supply to provide electrical current flow to the heating elements 110a, 110b.

FIG. 4 shows a schematic diagram of an embodiment of a switch circuit for the sensors 112a, 112b in FIG. 3. As depicted, the switch circuit includes a main switch 167 coupled to a power supply 164 and the timing unit 114. The main switch 167 is closed during the time interval of a toasting cycle set by the timing unit 114. Various types of mechanisms for operating the main switch 167 can be used. For instance, the user starts a toasting cycle by pushing down the operating knob. Then, the main switch 167 is closed and remains closed until a temperature gauge (not shown in FIG. 4) reaches the appropriate temperature that is commensurate with the dial setting of the timing unit 114. For another instance, the main switch 167 remains closed during a time span that is proportional to the dial setting of the timing unit 114.

The switch circuit also includes switching units 163a, 163b. The switching unit 163a is coupled to the heating elements 110a, 110b and sensor 112a, while the switching unit 163b is coupled to the sensor 112b and heating elements 110c, 110d. The switching unit 163a includes a relay 161a, such as solid state relay (SSR), and a switch 162a, such as a mechanical switch, coupled to the relay 161a. At the beginning of a toasting cycle, the switches 162a, 162b are closed to allow the electrical currents from the source 164 to flow therethough. If one of the toasting chambers, say 101a, is not loaded with any food item, the sensor 112a receives the radiation emitted from the heating element 110b, generates a sensor signal indicating the absence of the food item in the chamber, and sends the sensor signal to the relay 161a. If a food item 159 is loaded in the chamber, the radiation emitted from the heating element 110b is blocked by the food item 159. In this case, the radiation emitted by the heating elements 110a and scattered by the food item 159 may be directed by the lens 152 to the photosensitive element 150. Thus, the intensity of radiation incident on the photosensitive element 150 in the case with a food item in the toasting chamber may be different, typically weaker, from that in the case without food item. Based on the difference in intensity of the signal generated by the sensor 112a, it is determined whether or not a food item is loaded in the toasting slot of the toasting chamber 101a.

In response to the sensor signal, the relay 161a sends a switch signal to the switch 162a to operate the switch 162a. When the sensor signal indicates the absence of food item in the slot, the switch 162a is open to disconnect electrical current flow to the heating elements 110a, 110b.

The switch 162a is open as long as the sensor 112a sends a signal indicating the absence of food item in the chamber during a toasting cycle. If the user loads the food item 159 in the middle of the toasting cycle, the switch 162a is closed to allow an electrical current to flow through the heating elements 110a, 110b and thereby the food item is toasted during the remaining time interval of the toasting cycle. Thus, the toaster 100 can be used to generate two different toasting levels for two food items respectively loaded in the chambers 101a, 101b during one toasting cycle.

It is noted that the relay 161a and switch 162a are illustrated as separate elements. However, it should be apparent to those of ordinary skill that the relay 161a may also perform as a switch, i.e., the relay 161a may be used in place of the switching unit 163a. Likewise, the sensor 112a and the switching unit 163a can be combined into an integral element.

An alternative embodiment of a toaster can have one toasting chamber with one toasting slot. In this embodiment, the toaster 100 has only one sensor and one switching unit coupled to the sensor to control the electrical current flow through a pair of heating elements located in the toasting chamber.

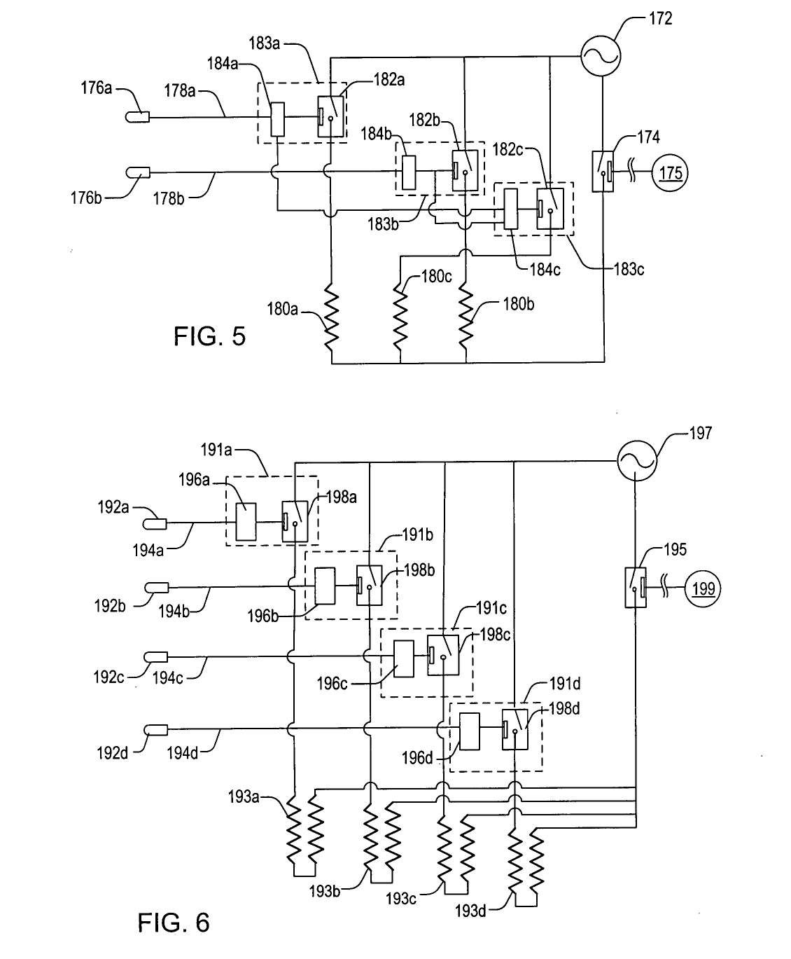

Another alternative embodiment of a toaster can have a different heating element arrangement. The heating elements 110b and 110c are combined to form an integral body and wound around a mica sheet disposed in the middle of the two toasting chambers, i.e., the two toasting chambers share a heating element. FIG. 5 shows a schematic diagram of another embodiment of a switch circuit used in a toaster. In FIG. 5, sensors 176a, 176b, switching units 183a, 183b, electrical wires 178a, 178b, switches 182a-182c, relays 184a, 184b, power supply 172, main switch 174, and timing unit 175 have similar structures and operational mechanisms to the sensor 112a, switching unit 163a, electrical wire 130a, switch 162a, relay 161a, power supply 164, main switch 167 and timing unit 114 in FIG. 4, with the difference that the sensors 176a, 176b send signals to another relay 184c. The heating elements 180a and 180b are used to toast a food item in one toasting chamber while the heating element 180b and 180c are used to toast a food item in another toasting chamber, i.e., the heating element 180c is shared by the two toasting chambers.

The relay 184c receives two signals from the sensors 176a, 176b and is operative to control the switch 182c. Each of the switches 182a, 182b is closed if a food item is loaded in the corresponding toasting chamber, while the switch 182c is closed if at least one of the toasting chamber is loaded. When the sensors 176a, 176b send signals indicating that both of the toasting chambers are not loaded, both switches 182a, 182b are open and the relay 184c opens the switch 182c to cut off the electrical current flowing through the heating element 182c.

In yet another embodiment, a toaster can have four toasting chambers and each chamber has one toasting slot, i.e., each chamber is dimensioned to accommodate one slice of bread. In still another embodiment, a toaster can have two toasting chambers and each chamber has two toasting slots. In those embodiments, a toaster can have four pairs of heating elements and four sensors respectively coupled to the four pairs of heating elements. FIG. 6 shows a schematic diagram of yet another embodiment of a switch circuit used in a toaster for toasting up to four slices of bread simultaneously. In FIG. 6, sensors 192a-192d, electrical wires 194a-194d, switching units 191a-191d, relays 196a-196d, switches 198a-198d, main switch 195, timing unit 199, and power supply 197 have similar structures and operational mechanisms to the sensor 112a, electrical wire 130a, switching unit 163a, relay 161a, switch 162a, main switch 167, timing unit 114, and power supply 164 in FIG. 4. The switches 198a-198d are respectively coupled to four pairs of heating elements 193a-193d, wherein each pair of heating elements is configured to toast a food item. Each pair of heating elements 193a-193d can be installed in one toasting chamber if the toaster has four toasting chambers with one toasting slot each. Alternatively, two pairs of heating elements can be installed in one toasting chamber if the toaster has two toasting chambers with two toasting slots each.

It is noted that the toaster 100 (FIG. 1) is shown to have only two toasting chambers. The switch circuit in FIG. 6 is designed to be used in a toaster that can toast up to four food items in a toasting cycle. However, it should be apparent to those of ordinary skill that the toaster 100 may have other suitable number of toasting chambers and other suitable number of slots for each chamber.

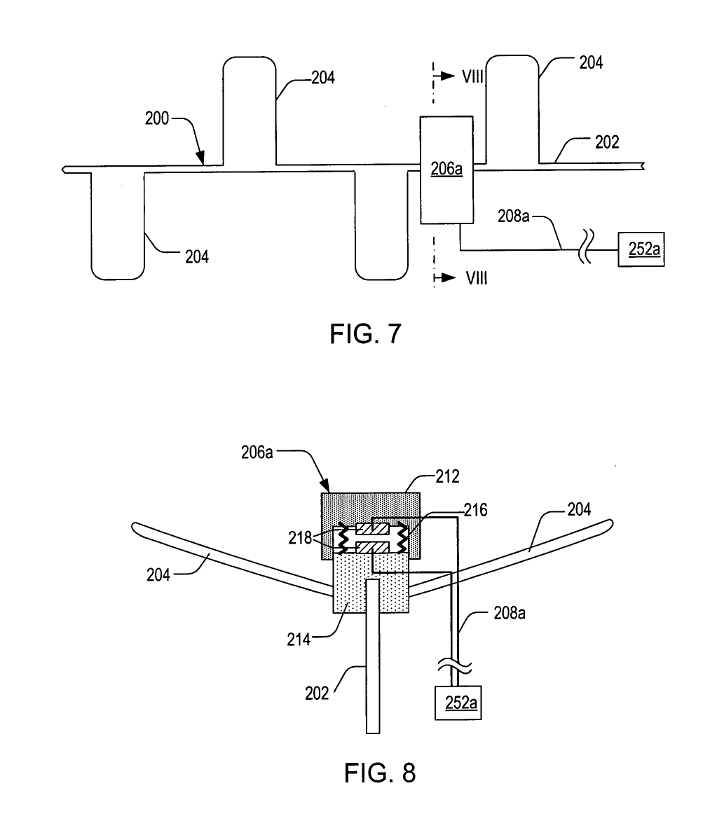

FIG. 7 shows a schematic top plan view of another embodiment of a sensor 206a mounted on a rack 200 of a toaster. FIG. 8 shows a schematic cross sectional view of the sensor 206a in FIG. 7, taken along the line VIII-VIII. As depicted, the sensor 206a includes: an upper electrical insulator 212 having a recess formed on the bottom central portion; and a lower electrical insulator 214 having a bottom portion securely mounted on an elongated bar 202 of the rack 200 and having a top portion slidably positioned inside the recess of the upper electrical insulator 212. Two electrodes 218 are positioned on the top surface of the lower electrical insulator 214 and the bottom surface of the upper electrical insulator 212 and coupled to a two-conductor electrical wire 208a. The wire 208a is coupled to a switching unit 252a that may be similar to the switching unit 163a (in FIG. 4). The upper and lower insulators 212, 214 are made of suitable heat-resistant material, such as glass, quarts, or ceramics.

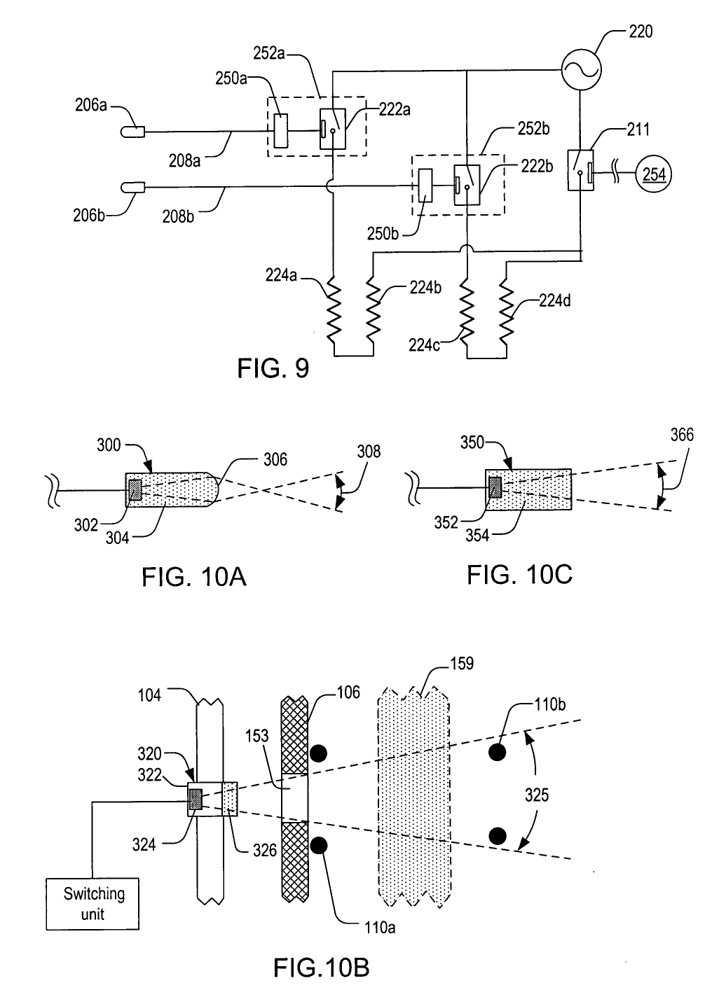

The electrodes 218 are in a spaced-apart relationship with each other by a resilient means, such as spring 216. The sensor 206a is positioned such that the upper electrical insulator 212 is pressed down by a food item to make the electrodes 218 come into contact with each other when the food item is loaded into the corresponding toasting slot. As will be discussed in conjunction with FIG. 9, the switching unit 252a coupled to the sensor 206a operates to control the electrical current flowing through the corresponding heating elements.

The movable bread supporting rack 200 can be made of suitable material, such as metal, and has an elongated bar 202 and flanges 204 extending outwardly from bar 202. The rack 146 in FIG. 2 can have the same shape as the rack 200. The racks 146, 200 can have other geometrical shape, such as wire in a sinusoidal shape.

FIG. 9 shows a schematic diagram of an embodiment of a switch circuit for the sensors in FIG. 7. As depicted, the switch circuit includes a main switch 211 coupled to a power supply 220 and a timing unit 254. The switch circuit also includes switching units 252a, 252b that may be similar to the switching unit 163a (in FIG. 4). The switch circuit in FIG. 9 operates in the similar manner as that in FIG. 4. When the user loads a food item in a toasting slot coupled to a sensor, say 206a, the electrodes 218 of the sensor come into contact with each other by the weight of the food item. Then, the sensor 206a generates a signal indicating the presence of a food item to the relay 250a. The relay 250a sends a signal to the switch 222a such that the switch 222a is closed and thereby an electrical current flows through the heating elements 224a, 224b during a toasting cycle. It is noted that the sensors 206a, 206b can be used in place of the sensors 182a, 182b in FIG. 5. Also, four sensors of the type 206a can be used in a toaster in which four food items can be loaded in a toasting cycle as discussed in conjunction with FIG. 6.

FIG. 10A is a schematic cross sectional view of an embodiment of a sensor 300 that might be used in the toaster of FIG. 1. In this embodiment, the generally cylindrical body 304 of the sensor 300 is formed of material, such as quartz or glass, that is transparent to the radiation emitted by the heating elements 110b during operation and a photosensitive element 302 is embedded in the sensor body 304. One end of the sensor body 304 has a curvature to direct the radiation emitted by the heating elements to the photosensitive element 302, i.e., the end portion operates as a lens. As in the case of FIG. 3, a portion of the heating elements is disposed within the field of view 308.

It is noted that the lens 152 (in FIG. 3) is an optional component in the cases where the photosensitive element 150 is sensitive enough to generate an electrical signal in response to the radiation energy without the lens 152. FIG. 10B is a schematic cross sectional view of another embodiment of a sensor 320 that might be used in the toaster of FIG. 1. As depicted, the sensor 320 includes a hollow cylinder having a disk 326 at one end and a circular plate 322 at the other end, wherein a photosensitive element 324 is fixedly mounted to the circular plate 322. The disk 326 operates as a heat shielding element, i.e., protects the photosensitive element 324 from the hot ambient air heated by heating elements 110a, 110b. The disk 326 is formed of a material, such as quartz or glass, that is transparent to the radiation emitted by the heating elements 110b. The size of the hole 153 and distance between the sensor 320 and mica plate 106 are adjusted such that a portion of the heating elements 110b is located within the field of view 325 of the photosensitive element 324. The sensor 320 may be used in place of the sensor 112a (in FIG. 3) if the photosensitive element 324 is sensitive enough to generate an electrical signal in response to the radiation energy without any focusing component, such as lens 152.

FIG. 10C shows a schematic cross sectional view of yet another embodiment of a sensor that might be used in the toaster of FIG. 1. As depicted, the generally cylindrical body 354 of the sensor 350 is formed of material, such as quartz or glass, that is transparent to the radiation emitted by the heating elements during operation and a photosensitive element 352 is embedded in the sensor body 354. The sensor body 354 has a substantially flat end facing a portion of the heating elements located within the field of view 366.

It is noted that the sensors 12a, 300, 320, and 350 in FIGS. 3 and 10A-10C may be mounted on any other suitable location, such as the space between the shielding 104 and outer housing 102, where the field of view of each sensor can cover a portion of the heating elements. It is also noted that each sensor may have other suitable shape. In the case where the sensor includes a photosensitive element embedded in a solid material and the photosensitive element responds to radiation in a certain wavelength range, the solid material is selected to transmit the radiation in the range and to stand the radiative and/or convective heat energy transferred thereto.

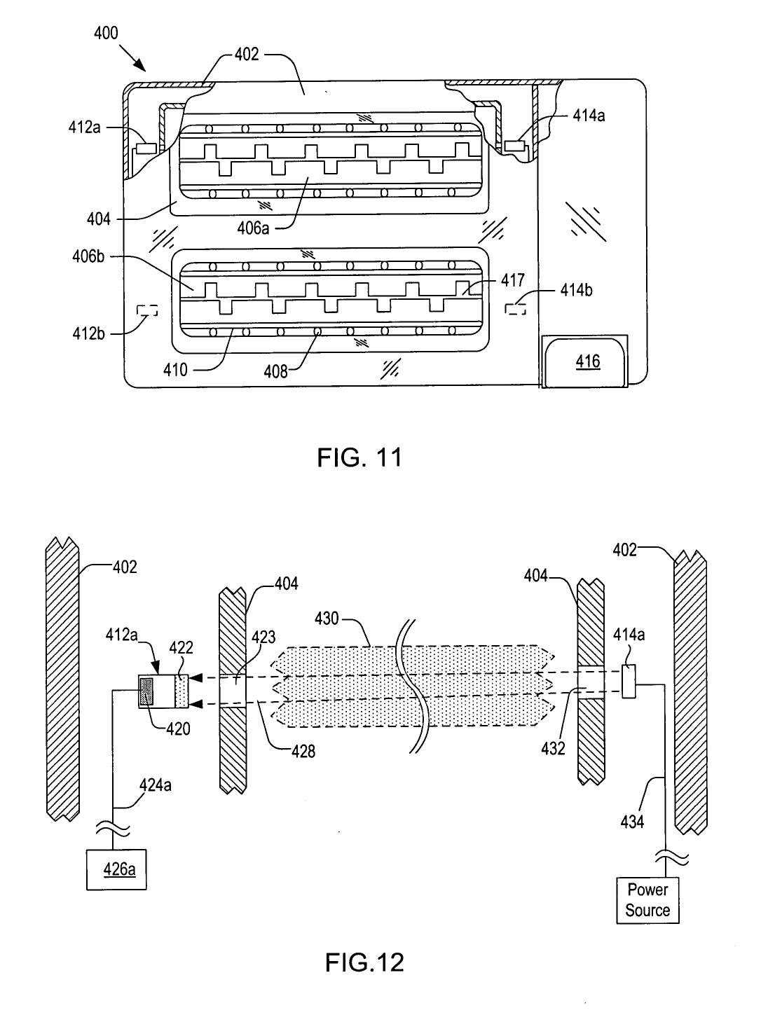

FIG. 11 shows a schematic top plan view of yet another embodiment of a sensor of a toaster. As depicted, the toaster 400 includes an outer housing 402, an inner housing or shielding 404, two toasting chambers 406a, 406b, and a manually operating knob 416. Each chamber or slot, say 406a, is provided with a pair of sensor 412a and light emitter 414a. Each chamber also includes a movable mounting rack 417, grids 408, and horizontal grid ribs 410. The toaster 400 is similar to the toaster 100 in FIG. 1, with the difference that a pair of sensor and light emitter is used in place of the sensor 112a.

FIG. 12 shows an enlarged view of a portion of the toaster 400, illustrating the pair of sensor 412a and light emitter 414a. For brevity, the grids 408, horizontal grid ribs 410, and the rack 417 are not shown in FIG. 12. The light emitter 414a, such as light emitting diode (LED), is disposed between the outer housing 402 and shielding 404 and sends light 428 through an opening or hole 432 in the shielding 404. The light 428 propagates through the chamber 406a and an opening or hole 423 formed in the opposite side of the hole 432 and is received by the sensor 412a.

The sensor 412a includes a photosensitive element 420 and optionally a disk 422 that is transparent to the light 428. The sensor 412a has similar structure and operational mechanisms as the sensor 320 (FIG. 10B). The intensity of light 428 incident on the photosensitive element 420 in the case with the food item 430 in the toasting chamber 406a may be different, typically weaker, from the case without food item. Based on the difference in intensity of the signal generated by the sensor 412a, it is determined whether or not a food item is loaded in the toasting chamber 406a.

The sensor 412a is coupled to a switching unit 426a via an electrical wire 424a. The switching unit 426a has similar structure and operational mechanisms as the switching unit 163a (FIG. 4). Also, the switch circuit associated with the switching unit 426a will be similar to the circuit shown in FIG. 4. Thus, for brevity, the switch circuit for the switching unit 426a is not repeated in the present document. The sensor 412a may have alternative embodiments that are similar to the embodiments 112a (FIG. 3), 300 (FIG. 10A) and 350 (FIG. 10C).

The light emitter 414a is coupled to a power source via an electrical wire 434. The electrical signals from the sensors 412a, 412b may include noise due to the stray light that is generated by the heating elements and directed to the sensors by scattering. If the noise level is significant to affect the proper operation of the sensor 412a, the operational wavelength ranges of the light emitter 414a and sensor 412a can be selected to discriminate the light 428 from the stray light. For instance, an LED emitting blue light is used in conjunction with a photosensitive element responsive to the blue light and/or a blue light filter attached to the disk 422.

It is noted that the sensors 412a, 412b and light emitters 414a, 414b in FIG. 11 may be mounted on any other suitable location insofar as the food item 430 can block at least a portion of the light 423 that is otherwise received by the sensors thereby the sensor 412a can generate a sensor signal indicating presence of the food item. It is also noted that the switch circuits similar to those shown in FIGS. 5 and 6 may be used with suitable number of sensor/light emitter pairs.

It is to be understood that the toasters described in FIGS. 1-12 are exemplary, rather than exhaustive, and that the toasters may have other configurations. For instance, the toasters may be formed integral with other electrical appliances, such as microwave oven or egg cooker. For another instance, the toasters may have several buttons to control the heat intensity during a toasting cycle, such as defrost, warm, or bagel. However, it should be apparent to those of ordinary skill that similar sensors and switch circuits as those depicted in FIGS. 1-12 can be used in those various embodiments.

While the invention has been described in detail with reference to specific embodiments thereof, it will be apparent to those skilled in the art that various changes and modifications can be made, and equivalents employed, without departing from the scope of the appended claims.

What is claimed is:

1. A toaster having at least one toasting slot, comprising:
at least one sensor operative to generate a sensor signal indicating whether or not a food item is loaded in said slot;
heating elements for generating heat energy to toast a food item loaded in said toasting slot by use of an electrical current; and
at least one switching unit responsive to said sensor signal and operative to control the electrical current.

2. A toaster as recited in claim 1, wherein said heating elements generate radiation by use of the electrical current and wherein said sensor includes a photosensitive element responsive to the radiation.

3. A toaster as recited in claim 2, wherein said sensor includes a hollow cylinder having closed ends to form a space therewithin and said photosensitive element is disposed within said space.

4. A toaster as recited in claim 3, wherein one of said ends is a disk formed of material transparent to the radiation.

5. A toaster as recited in claim 3, wherein one of said ends is a lens formed of material transparent to the radiation and operative to direct a portion of the radiation to the photosensitive element.

6. A toaster as recited in claim 1, wherein said heating elements generate radiation by use of the electrical current and wherein said sensor includes:
a generally cylindrical body formed of material transparent to the radiation; and
a photosensitive element embedded in said body and responsive to the radiation.

7. A toaster as recited in claim 1, wherein an end portion of said body has a curvature to direct a portion of the radiation to said photosensitive element.

8. A toaster as recited in claim 1, wherein said switching unit includes a relay coupled to said sensor.

9. A toaster as recited in claim 8, wherein said switching unit further includes a switch coupled to said relay.

10. A toaster as recited in claim 1, further comprising:
a movable rack for supporting the food item,
wherein said sensor is mounted on said movable rack and includes a pair of electrodes in a spaced-apart relationship with each other by a spring and, when said spring is compressed by a weight of the food item, said pair of electrodes contact each other to generate a sensor signal indicating the food item is loaded in said slot.

11. A toaster as recited in claim 10, further comprising:
an upper electrical insulator having an upper surface to be in contact with the food item and a recessed bottom portion; and
a lower electrical insulator configured to be securely mounted on said rack and having a top portion slidably mounted in said recessed bottom portion,
wherein said pair of electrodes are respectively positioned beneath said recessed bottom portion and on said top portion.

12. A toaster as recited in claim 1, further comprising:
a light emitter for emitting radiation toward said sensor,
wherein said sensor includes a photosensitive element responsive to the radiation.

13. A method for operating a toaster having at least one toasting slot with heating elements to be energized by an electrical current from a power source, comprising:
causing a sensor associated with said toasting slot to generate a signal that indicates whether or not a food item is loaded in said slot; and
causing a switching unit coupled to the power source to control the electrical current in response to the signal.

14. A method as recited in claim 13, wherein said heating elements generate radiation by use of the electrical current and said sensor includes a photosensitive element responsive to the radiation and wherein said step of causing a sensor associated with said toasting slot to generate a signal includes:
exposing said photosensitive elements to a portion of the radiation.

15. A method as recited in claim 14, wherein said sensor further includes a light focusing element and wherein said step of causing a sensor associated with said toasting slot to generate a signal includes:
directing a portion of the radiation to said photosensitive elements by use of said light focusing element.

16. A method as recited in claim 13, wherein said sensor includes a pair of electrodes in a spaced-apart relationship with each other by a spring and wherein said step of causing a sensor associated with said toasting slot to generate a signal includes:
causing said spring to be compressed by a weight of the food item such that said pair of electrodes contact each other to generate a signal indicating the food item is loaded in said slot.

17. A method as recited in claim 13, wherein said toaster includes a light emitter for emitting radiation and said sensor includes a photosensitive element responsive to the radiation and wherein said step of causing a sensor associated with said toasting slot to generate a signal includes:
causing said light emitter to emit the radiation; and
exposing said photosensitive elements to a portion of the radiation.
